(19) United States
(12) Patent Application Publication
(10) Pub. No.: US 2003/0074800 A1
(43) Pub. Date: Apr. 24, 2003

(54) Retractable ruler having positioning and holding function

(76) Inventor: Yu Mi Huang, Taipei Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/050,819

(22) Filed: Jan. 18, 2002

(30) Foreign Application Priority Data
Oct. 23, 2001 (TW) 90218109

(51) Int. Cl. G01B 3/08

(52) U.S. Cl. 33/486

(57) ABSTRACT

A retractable ruler having positioning and holding function comprises a first element and a second element. A receiving track is formed on the bottom face of the first element. The second element can be received in the receiving tack, and protrudes out of an opening of the receiving track. Scales are disposed at two sides of the surface of the first element. A holding element is positioned on the second element, and protrudes out of a guide track of the first element. The second element is led to move retractably by the holding element. Scales are disposed at two sides of the second element, or the second element forms a knife shape. The guide track is connected, and is separated into several positioning points. The first element can be pivoted with the holding element as a center. The holding element can be held to steadily use the first element.

### FIELD OF THE INVENTION

The present invention relates to a retractable ruler having positioning and holding function and, more particularly, to a ruler-in-ruler type retractable ruler.

### BACKGROUND OF THE INVENTION

As shown in FIG. 1, a conventional ruler 1 is only a flat and straight rectangular sheet with scales disposed at two sides thereof. It is necessary to press hard the top face with two or more fingers to perform the action of drawing lines. Because the ruler 1 has a limited length, and cannot be extended for measurement, one can only make a mark and then shift the ruler 1 when measuring a long body. In other words, the ruler 1 is not convenient to use and cannot be expanded for measurement. Accordingly, the present invention aims to resolve the above problems.

### SUMMARY OF THE INVENTION

The primary object of the present invention is to provide a retractable ruler having positioning and holding function to generate ruler-in-ruler type double ruler utility. In other words, a second element of child ruler can protrude out from a first element of mother ruler. The child ruler is led to move by a retaining element. The mother ruler can be positioned for use with a single finger pressing the retaining element. Moreover, the mother ruler can be pivoted with the retaining element as a center.

The secondary object of the present invention is to provide a retractable ruler having positioning and holding function, wherein the second element becomes a knife to facilitate paper cutting and letter opening.

Another object of the present invention is to provide a retractable ruler having positioning and holding function, wherein moving and positioning function of the second element of child ruler can be achieved to only protrude out an appropriate length by a plurality of positioning points on a guide track disposed on the first element of mother ruler matched with the retractable retaining element.

To achieve the above objects, the present invention comprises a first element and a second element. A receiving track is formed on the bottom face of the first element so that the second element can be received therein and protrude out of the opening of the receiving track. Scales are disposed at two sides of the surface of the first element. A holding element is provided and positioned on the second element, and protrudes out of a guide track of the first element. The second element is led to move retractably by the holding element. Scales are also disposed at two sides of the second element, or the second element forms a knife shape. The guide track is connected, and is separated into several positioning points. The positioning points can be used for adjusting the position of the holding element. The first element can be pivoted with the holding element as a center. The holding element can be held to let the first element be steadily used.

The various objects and advantages of the present invention will be more readily understood from the following detailed description when read in conjunction with the appended drawing, in which:

### BRIEF DESCRIPTION OF THE DRAWINGS

FIG. 1 is a perspective view of a conventional ruler;

FIG. 2 is a perspective view of the present invention;

FIG. 3 is an exploded perspective view of the present invention;

FIG. 4 is a perspective view according to an embodiment of the present invention having a ruler type second element;

FIG. 5 is a perspective view according to another embodiment of the present invention having a knife type second element;

FIG. 6 is a partly cross-sectional view of the present invention after the retaining element is assembled; and

FIG. 7 is a cross-sectional view of FIG. 6 with the retaining element pulled upwards.

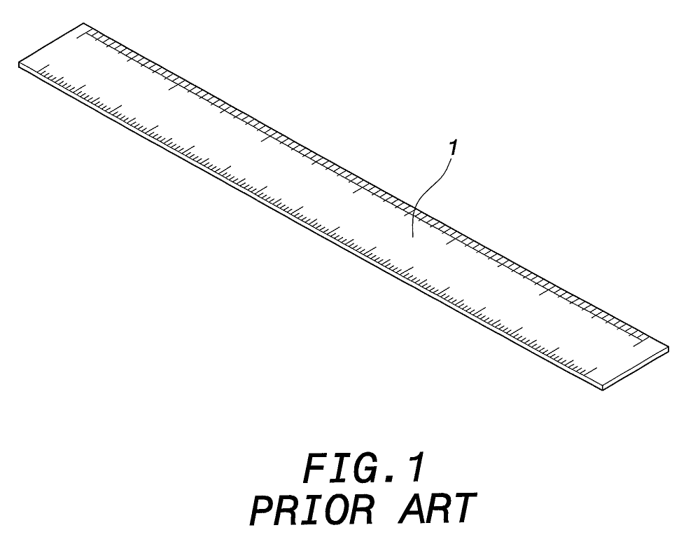

### DETAILED DESCRIPTION OF THE PREFERRED EMBODIMENTS

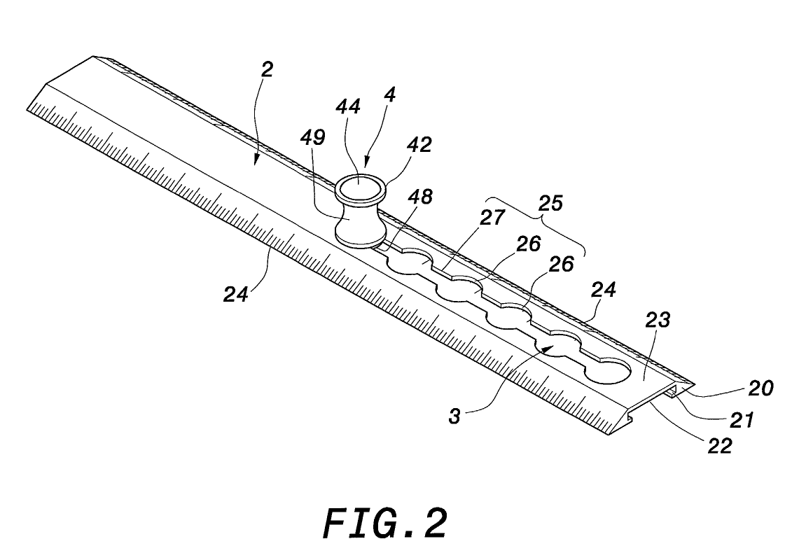

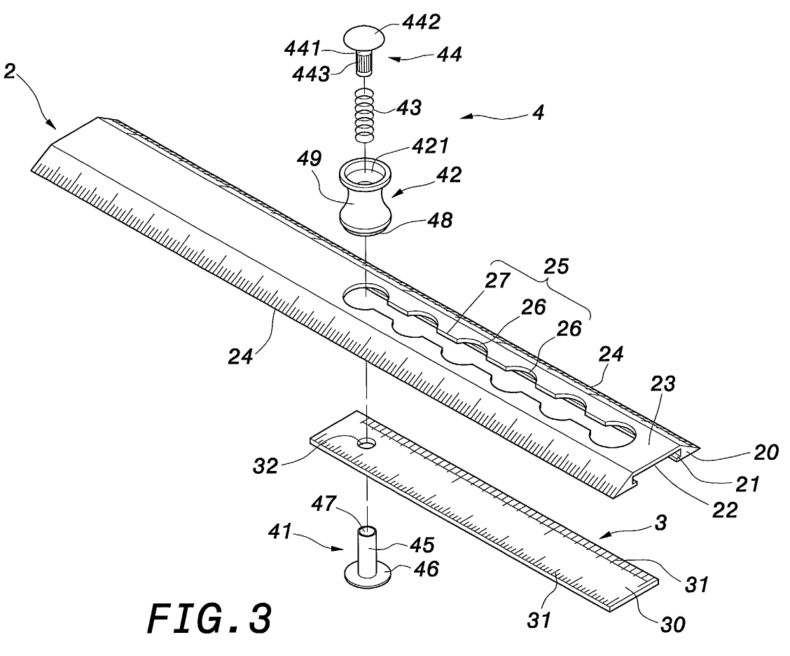

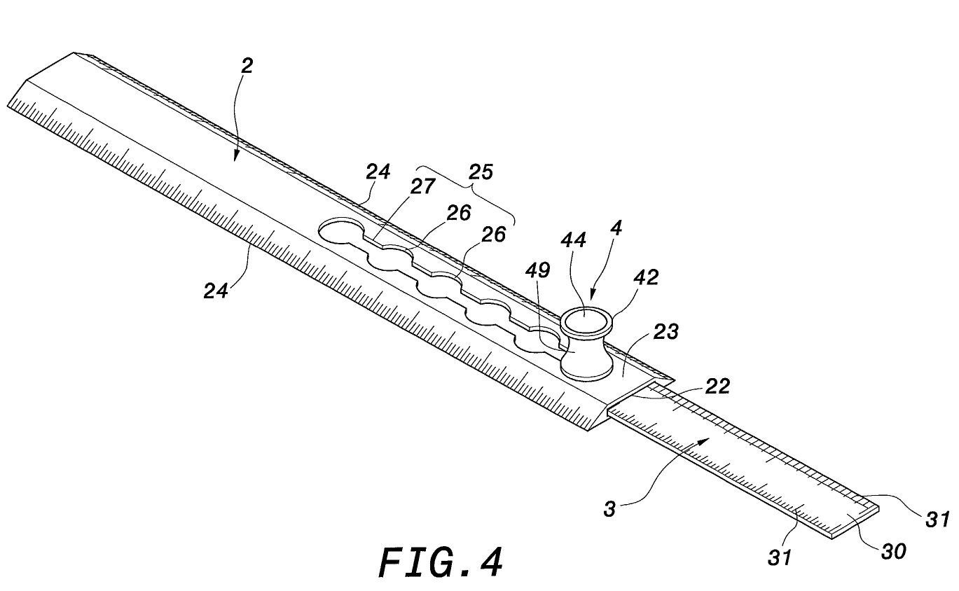

As shown in FIGS. 2 and 3, a retractable ruler having positioning and holding function of the present invention comprises a first element 2 and a second element 3. A receiving track 21 is formed on the bottom face of the first element 2. The receiving track 21 is a lip-shaped groove (shown in the figure) or a dovetailed groove. The first element 2 is a rectangular main body 20 having an appropriate height. The second element 3 can be received in the receiving track 21, and protrudes out of an opening 22 at one end of the receiving track 21. Scales 24 are disposed at two sides of a surface 23 of the first element 2. The positions where the scales 24 are disposed are bevel-shaped to facilitate use. A main body 30 of the second element 3 is a flat and straight rectangular sheet. Scales 31 are disposed at two sides of the main body 30. As shown in FIG. 4, the second element 3 can protrude out of the first element 2 to facilitate measurement.

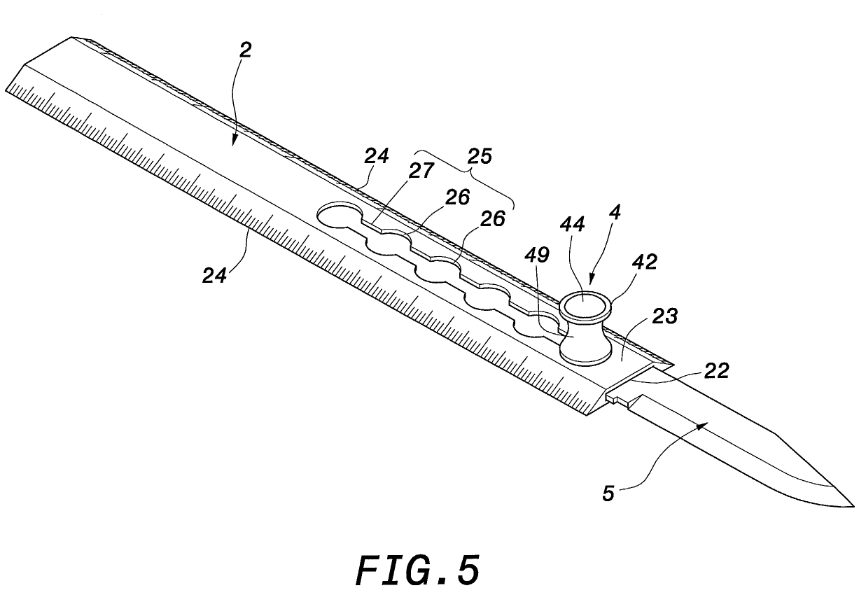

A holding element 4 is also provided. The holding element 4 is positioned and joined on the second element 3. The second element 3 protrudes out of the opening 22 of a guide track 25 of the first element 2. The second element 3 is led to retractably move relative to the first element 2 by the holding element 4. In addition to being a basic ruler shape, the whole second element 5 can form a knife shape (as shown in FIG. 5), or only the outer end of the second element 3 can form a knife shape.

The guide track 25 is connected, and is separated into a plurality of positioning points 26. The positioning points 26 are alternately arranged grooves. Two sides of a groove passage 27 are concavely cut to form a plurality of circular grooves, each with two semicircular grooves at two sides thereof. The positioning points 26 can be used to adjust the position of the retractable holding element 4. Moreover, the first element 2 can be pivoted with the holding element 4 as a center. The holding element 4 can be held to let the first element 2 be steadily used to facilitate line drawing and measurement.

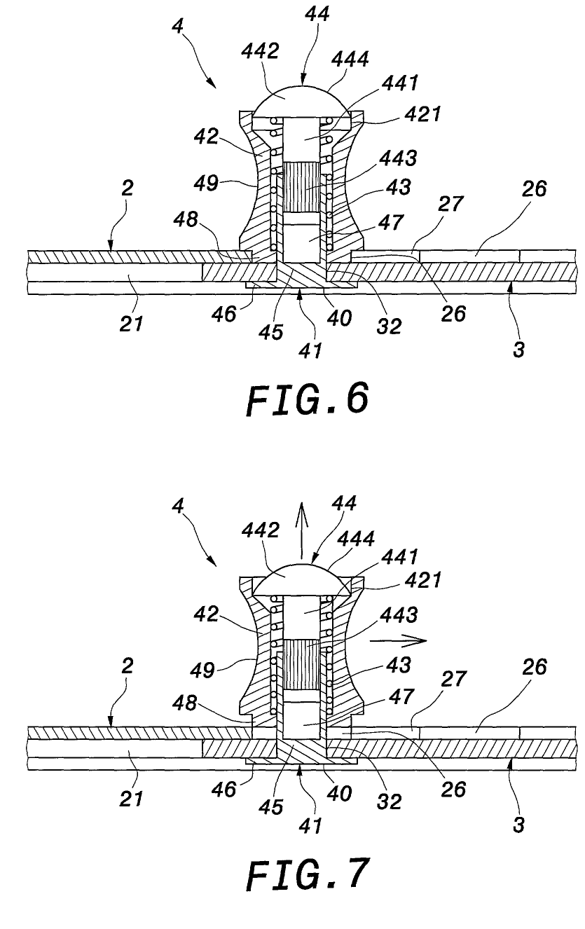

As shown in FIGS. 3 and 6, the holding element 4 is a retractable positioning element comprising a bottom fastener 41, a slide sleeve 42, a resilient element 43, and a top fastener 44. The second element 3 has a through hole 32. The bottom fastener 41 includes a column body 45. The column body 45 has a bottom projective edge 46. A fixing groove 47 is disposed on the top end face of the column body 45. The column body 45 passes through the through hole 32 of the second element 3. The slide sleeve 42 is a percurrent tube. A projective ring 48 is disposed on the bottom end face of the slide sleeve 42. The resilient element 43 is sleeved between the inner face of the slide sleeve 42 and the outer surface of the column body 45 of the bottom fastener 41. The top fastener 44 includes a stopper column 441 having a top projective edge 442. A stripy retaining portion 443 is disposed near the lower end peripheral face of the stopper column 441. The retaining portion 443 is inserted and positioned in the fixing groove 47 of the column body 45.

The bottom face of the bottom fastener 41 is flat. When the bottom fastener 41 is pressed to move by the top fastener 44, the bottom fastener 41 moves downwards to let the bottom face 40 of the bottom fastener 41 be appressed on an object face (not shown). An outer peripheral face 49 of the slide sleeve 42 is an annular concave arc contracting toward the center so that the outer peripheral face 49 can be conveniently retained with finger. In this way, the slide sleeve 42 is led to move upwards or downwards. FIG. 7 shows a state that the slide sleeve 42 is moved upwards. At this time, the projective ring 48 of the slide sleeve 42 separates from the original positioning point 26 nearest to the center. In other words, the projective ring 48 is no longer inserted in the circular grooves alternately arranged at the guide track 25 of the first element 2. Therefore, the slide sleeve 42 can be moved toward the opening 22 along the receiving track 21. A flared annular groove 421 is disposed on the inner face near the upper end of the slide sleeve 42. The annular groove 421 forms a limit structure after the top projective edge 442 moves. A top face 444 of the top fastener 44 is spherical. Part of the top face 444 protrudes out of the top face of the slide sleeve 42 to facilitate pressing of finger.

To sum up, in the present invention, the second element of child ruler is embedded and inserted in the first element of mother ruler, and the second element is led to move relative to the first element by using the holding element so that the child ruler or a knife can protrude out from the mother ruler to generate extended measurement function and cutting and opening utility. Additionally, the holding element can be pressed by only a single finger to tightly press the mother ruler on an object face or a paper, thereby facilitating measurement and line drawing. Moreover, the concave outer peripheral face of the slide sleeve can be comfortably held by finger to conform to human engineering. The first element can be easily moved with two fingers. The second element can be led to move by retractably moving the holding element. The projective ring of the slide sleeve is used to generate shifting and fixing function to the positioning points of circular groove shape. The second element can be positioned when the holding element is released. In addition to moving unidirectionally toward an end opening, the second element can also move toward two end openings. When the top fastener of the holding element is pressed downwards, the first element can be pivoted to perform the function of drawing lines slantingly, which cannot be achieved with a conventional ruler.

Although the present invention has been described with reference to the preferred embodiment thereof, it will be understood that the invention is not limited to the details thereof. Various substitutions and modifications have been suggested in the foregoing description, and other will occur to those of ordinary skill in the art. Therefore, all such substitutions and modifications are intended to be embraced within the scope of the invention as defined in the appended claims.

I claim:

1. A retractable ruler having positioning and holding function comprising:
a first element with a receiving track formed at a bottom face thereof, said receiving track having at least an opening, a top face of said first element having a guide track, scales being disposed at two sides of a surface of said first element;
a second element embedded and inserted in said receiving track of said first element, said second element being capable of moving along said receiving track to protrude out of said opening of said receiving track; and
a holding element positioned and joined on said second element, said holding element protruding out of a guide track of said first element, said holding element being used to lead said second element to retractably move.

2. The retractable ruler having positioning and holding function as claimed in claim 1, wherein scales are disposed at two sides of said second element.

3. The retractable ruler having positioning and holding function as claimed in claim 1, wherein an outer end of said second element forms a knife shape.

4. The retractable ruler having positioning and holding function as claimed in claim 1, wherein said second element forms a knife shape.

5. The retractable ruler having positioning and holding function as claimed in claim 1, wherein said holding element is a retractable positioning element, said guide track of said first element being connected via a groove passage and separated into a plurality of positioning points, said holding element being adjusted and positioned at any of said positioning points, said positioning points being of circular groove shape.

6. The retractable ruler having positioning and holding function as claimed in claim 5, wherein said retractable positioning element comprises a bottom fastener, a slide sleeve, a resilient element, and a top fastener, said second element having a through hole, said bottom fastener including a column body, said column body including a bottom projective edge, a fixing groove being disposed on a top end face of said column body, said column body passing through said through hole of said second element, said slide sleeve being a percurrent tube, a bottom end of said slide sleeve having a projective ring, said projective ring being positioned at said positioning points of said guide track, said resilient element being sleeved between an inner face of said slide sleeve and said column body of said bottom fastener, said top fastener comprising a stopper column, said stopper column having a top projective edge, a lower end of said stopper column being fixed in said fixing groove of said column body.

7. The retractable ruler having positioning and holding function as claimed in claim 6, wherein a bottom face of said bottom fastener is flat, and the bottom face of said bottom fastener is appressed on an object face when said bottom fastener is pressed to move by said top fastener.

8. The retractable ruler having positioning and holding function as claimed in claim 6, wherein an outer peripheral face of said slide sleeve is an annular concave arc contracting toward the center.

9. The retractable ruler having positioning and holding function as claimed in claim 6, wherein a top face of said top fastener is spherical, and the top face partly protrudes out of the top face of said slide sleeve.
